(19) United States
(12) Patent Application Publication
(10) Pub. No.: US 2026/0254702 A1
(43) Pub. Date: Aug. 27, 2026

(54) MULTI-DIMENSIONAL CONSTELLATIONS WITH LOW PEAK-TO-AVERAGE POWER RATIO

(71) Applicant: QUALCOMM Incorporated, San Diego, CA (US)

(72) Inventors: Wei YANG, San Diego, CA (US); Mahmoud TAHERZADEH BOROUJENI, San Diego, CA (US)

(21) Appl. No.: 19/063,916

(22) Filed: Feb. 26, 2025

(51) Int. Cl. H04L 27/34; H04L 1/00; H04L 27/36

(52) U.S. Cl. CPC H04L 27/3405; H04L 1/0057; H04L 27/36

(57) ABSTRACT

Various aspects of the present disclosure generally relate to wireless communication. In some aspects, a transmitting device may obtain a constellation that comprises 2^{k} points selected from a set of points associated with M quadrature phase shift keying (QPSK) constellations, wherein k and M are positive integers. The transmitting device may modulate one or more groups of k bits to one or more sets of M QPSK symbols based at least in part on the constellation, wherein each point of the 2^{k} points corresponds to a respective set of M QPSK symbols of the one or more sets of M QPSK symbols. The transmitting device may transmit a signal that includes the one or more sets of M QPSK symbols. Numerous other aspects are described.

### FIELD OF THE DISCLOSURE

Aspects of the present disclosure generally relate to wireless communication and specifically relate to techniques, apparatuses, and methods associated with multi-dimensional constellations with low peak-to-average power ratio.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

In a wireless communication system, information is generally represented as a sequence of binary bits that are modulated to an analog signal waveform that is then transmitted to a receiver over a wireless communication channel. At the receiver, the received signal is mapped back to binary bits, with the received binary information estimating or corresponding to the transmitted binary information. In some examples, to modulate the analog signal, phase-shift keying (PSK) modulation techniques may be used, such as binary PSK (BPSK), π/2 BPSK, or quadrature PSK (QPSK), among other examples. PSK modulation may involve varying a phase of a carrier wave having a constant frequency between a finite number of phases, where each phase corresponding to a unique set of one or more bits.

Some modulation techniques, such as BPSK or QPSK modulation, are associated with constellation diagrams, where one or more bits are mapped to a complex modulation symbol that corresponds to a single point in a two-dimensional constellation (e.g., a two-point constellation for BPSK modulation, or a four-point constellation for QPSK modulation). For example, a coordinate space for the multi-dimensional constellation may include a horizontal axis to represent an in-phase or real component of the complex modulation symbol and a vertical axis to represent a quadrature or imaginary component of the complex modulation symbol. In some cases, the angle of a point in the constellation (e.g., measured counterclockwise form the horizontal axis) may represent a phase shift of the analog signal waveform (e.g., a phase transition between symbols of the analog signal waveform), and a distance of a point in the constellation from an origin of the constellation may correspond to an amplitude or power of the analog signal waveform.

### SUMMARY

Some aspects described herein relate to a transmitting device. The transmitting device may include a processing system. The processing system may include one or more processors and one or more code-storing memories coupled with the one or more processors. The processing system may be configured to cause the transmitting device to obtain a constellation that comprises 2^{k} points selected from a set of points associated with M quadrature phase shift keying (QPSK) constellations, wherein k and M are positive integers. The processing system may be configured to cause the transmitting device to modulate one or more groups of k bits to one or more sets of M QPSK symbols based at least in part on the constellation, wherein each point of the 2^{k} points corresponds to a respective set of M QPSK symbols of the one or more sets of M QPSK symbols. The processing system may be configured to cause the transmitting device to transmit a signal that includes the one or more sets of M QPSK symbols.

Some aspects described herein relate to a receiving device. The receiving device may include a processing system. The processing system may include one or more processors and one or more code-storing memories coupled with the one or more processors. The processing system may be configured to cause the receiving device to receive a signal that includes one or more sets of M QPSK symbols. The processing system may be configured to cause the receiving device to demodulate the one or more sets of M QPSK symbols in accordance with a constellation to obtain one or more groups of k bits, wherein the constellation comprises 2^{k} points selected from a set of points associated with M QPSK constellations, wherein each point of the 2^{k} points corresponds to a respective set of M QPSK symbols of the one or more sets of M QPSK symbols, and wherein k and M are positive integers.

Some aspects described herein relate to a method of wireless communication performed by a transmitting device. The method may include obtaining a constellation that comprises 2^{k} points selected from a set of points associated with M QPSK constellations, wherein k and M are positive integers. The method may include modulating one or more groups of k bits to one or more sets of M QPSK symbols based at least in part on the constellation, wherein each point of the 2^{k} points corresponds to a respective set of M QPSK symbols of the one or more sets of M QPSK symbols. The method may include transmitting a signal that includes the one or more sets of M QPSK symbols.

Some aspects described herein relate to a method of wireless communication performed by receiving device. The method may include receiving a signal that includes one or more sets of M QPSK symbols. The method may include demodulating the one or more sets of M QPSK symbols in accordance with a constellation to obtain one or more groups of k bits, wherein the constellation comprises 2^{k} points selected from a set of points associated with M QPSK constellations, wherein each point of the 2^{k} points corresponds to a respective set of M QPSK symbols of the one or more sets of M QPSK symbols, and wherein k and M are positive integers.

Some aspects described herein relate to a non-transitory computer-readable medium that stores a set of instructions for wireless communication by a transmitting device. The set of instructions, when executed by one or more processors of the transmitting device, may cause the transmitting device to obtain a constellation that comprises 2^{k} points selected from a set of points associated with M QPSK constellations, wherein k and M are positive integers. The set of instructions, when executed by one or more processors of the transmitting device, may cause the transmitting device to modulate one or more groups of k bits to one or more sets of M QPSK symbols based at least in part on the constellation, wherein each point of the 2^{k} points corresponds to a respective set of M QPSK symbols of the one or more sets of M QPSK symbols. The set of instructions, when executed by one or more processors of the transmitting device, may cause the transmitting device to transmit a signal that includes the one or more sets of M QPSK symbols.

Some aspects described herein relate to a non-transitory computer-readable medium that stores a set of instructions for wireless communication by a receiving device. The set of instructions, when executed by one or more processors of the receiving device, may cause the receiving device to receive a signal that includes one or more sets of M QPSK symbols. The set of instructions, when executed by one or more processors of the receiving device, may cause the receiving device to demodulate the one or more sets of M QPSK symbols in accordance with a constellation to obtain one or more groups of k bits, wherein the constellation comprises 2^{k} points selected from a set of points associated with M QPSK constellations, wherein each point of the 2^{k} points corresponds to a respective set of M QPSK symbols of the one or more sets of M QPSK symbols, and wherein k and M are positive integers.

Some aspects described herein relate to an apparatus for wireless communication. The apparatus may include means for obtaining a constellation that comprises 2^{k} points selected from a set of points associated with M QPSK constellations, wherein k and M are positive integers. The apparatus may include means for modulating one or more groups of k bits to one or more sets of M QPSK symbols based at least in part on the constellation, wherein each point of the 2^{k} points corresponds to a respective set of M QPSK symbols of the one or more sets of M QPSK symbols. The apparatus may include means for transmitting a signal that includes the one or more sets of M QPSK symbols.

Some aspects described herein relate to an apparatus for wireless communication. The apparatus may include means for receiving a signal that includes one or more sets of M QPSK symbols. The apparatus may include means for demodulating the one or more sets of M QPSK symbols in accordance with a constellation to obtain one or more groups of k bits, wherein the constellation comprises 2^{k} points selected from a set of points associated with M QPSK constellations, wherein each point of the 2^{k} points corresponds to a respective set of M QPSK symbols of the one or more sets of M QPSK symbols, and wherein k and M are positive integers.

The systems, methods, and devices of this disclosure each have several innovative aspects, no single one of which is solely responsible for the desirable attributes disclosed herein.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example disaggregated network node architecture.

FIG. 3 is a diagram illustrating an example of a transmit chain and a receive chain.

FIG. 4 is a diagram illustrating an example of modulation techniques use multi-dimensional constellations to support a low peak-to-average power ratio (PAPR).

FIG. 5 is a diagram illustrating examples of constellation diagrams that support low PAPR modulation.

FIG. 6 is a diagram illustrating an example process performed, for example, at a transmitting device or an apparatus of a transmitting device.

FIG. 7 is a diagram illustrating an example process performed, for example, at a receiving device or an apparatus of a receiving device.

FIG. 8 is a diagram of an example apparatus for wireless communication.

FIG. 9 is a diagram of an example apparatus for wireless communication.

### DETAILED DESCRIPTION

A wireless communication system may use one or more modulation techniques to map a sequence of bits (e.g., input bits, or information bits) to an analog signal waveform that is transmitted to a receiver over a wireless communication channel. In some examples, the wireless communication system may use phase-shift keying (PSK) modulation techniques, which may convey the sequence of binary bits in accordance with shifts in the phase of the analog signal waveform (e.g., phase transitions). For example, each bit of the sequence of binary bits may be mapped to a point in a two-dimensional constellation. The multi-dimensional constellation may include a horizontal axis to represent an in-phase or real component of the complex modulation symbol and a vertical axis to represent a quadrature or imaginary component of the complex modulation symbol. In some cases, the angle of a point in the constellation (e.g., measured counterclockwise form the horizontal axis) may represent a phase shift of the analog signal waveform (e.g., a phase transition between symbols of the analog signal waveform), and a distance of a point in the constellation from an origin of the constellation may correspond to an amplitude or power of the analog signal waveform. In some examples, for PSK modulation, points in the constellation may be located along a circle centered at the origin of the constellation, such that the analog signal waveform may be transmitted according to a constant power or amplitude.

In some examples, PSK modulation techniques may include binary PSK (BPSK) modulation, which involves shifting the phase of the analog signal waveform between two phases separated by π radians (180 degrees), where each phase conveys a respective value for a bit (e.g., a value of 1 or 0). BPSK modulation uses a constellation with two points, which may be located at opposite points on the circle (e.g., separated by 180 degrees). In some examples, π/2 BPSK modulation may be used, which may involve using two BPSK constellations, where a first BPSK constellation is shifted by π/2 radians (90 degrees) from a second BPSK constellation. In π/2 BPSK modulation, each bit of the sequence of bits may be modulated using a constellation selected in accordance with a position of the bit within the sequence of bits. For example, bits in even-numbered positions may be modulated according to the first BPSK constellation, and bits in odd-numbered positions may be modulated according to the second BPSK constellation. Accordingly, π/2 BPSK modulation may be associated with a greater quantity of phase transitions relative to BPSK modulation, even when the sequence of bits includes consecutive sequences of 1 bit values or 0 bit values, which may improve signal quality associated with communications between devices relative to using BPSK modulation.

PSK modulation techniques also include quadrature PSK (QPSK) modulation.

In QPSK modulation, the constellation includes four points equally spaced along the circle. Accordingly, by using four points corresponding to four phases of the analog signal waveform, QPSK modulation may allow encoding two bits for each modulation symbol. For example, a first point of the constellation may correspond to 00, a second point may correspond to 01, a third point of the constellation may correspond to 10, and a fourth point of the constellation may correspond to 11. Consequently, QPSK modulation may support double the data rate relative to BPSK or π/2 BPSK modulation.

In some cases, however, different modulation techniques may be associated with a different spectral efficiency and peak-to-average power ratio (PAPR) for the resulting analog signal waveform. In some examples, a low PAPR may be associated with greater connection reliability and coverage gains relative to high PAPR, such as in coverage-limited scenarios. However, there is typically a tradeoff between spectral efficiency and PAPR, as modulation schemes with a relatively high spectral efficiency usually have a large PAPR, and modulation schemes with a relatively low PAPR usually have a low spectral efficiency. For example, π/2 BPSK modulation has a much lower PAPR relative to QPSK modulation, but π/2 BPSK modulation may only support about half the spectral efficiency relative to QPSK modulation. Consequently, π/2 BPSK modulation is typically used only when a very low spectral efficiency (e.g., less than 0.2) is tolerable, because π/2 BPSK modulation is associated with a degraded coding gain at higher coding rates. Accordingly, modulation techniques that may exist between QPSK and π/2 BPSK modulation in terms of PAPR and spectral efficiency may be useful (e.g., higher spectral efficiency than π/2 BPSK modulation and lower PAPE than QPSK modulation), as these modulation techniques may support increased coverage in coverage-limited scenarios while supporting increased spectral efficiency (e.g., data rates) relative to π/2 BPSK modulation.

In some cases, coding techniques may be used to decrease the PAPR associated with QPSK modulation. For example, Trellis coding may be applied with QPSK modulation, which may be used to control the phase transition (e.g., change the phase transition, or prevent the phase transition from changing) between some modulation symbols, which may improve (e.g., reduce) the PAPR. However, Trellis coding for a modulation symbol may be performed in accordance with encoding of other modulation symbols (e.g., Trellis coding introduces memory across the modulation symbols). Consequently, a receiving device that demodulates QPSK with Trellis coding may perform Trellis decoding (e.g., using a Viterbi algorithm) to demodulate the symbols, which may be performed jointly for all received symbols. Accordingly, as the encoding for each modulation symbol is dependent on the encoding of other modulation symbols, using Trellis decoding may increase demodulation complexity and reduce performance at the decoder relative to QPSK modulation, as the decoder is not able to perform Trellis decoding in parallel for multiple symbols.

Various aspects relate generally to multi-dimensional constellations with low PAPR. Some aspects more specifically relate to modulation techniques using multi-dimensional constellations that may achieve decreased PAPR relative to QPSK modulation and increased spectral efficiency relative to π/2 BPSK modulation. In some aspects, the modulation techniques may use a constellation that includes a subset of points selected from a set of points associated with a QPSK constellation, and jointly modulating one or more groups of k bits of the sequence of bits to one or more sets of M symbols (e.g., QPSK symbols) using the subset of points in the constellation. In some aspects, the constellation may be selected in accordance with the size of the groups of bits (e.g., k) and the size of the sets of symbols (e.g., M). For example, the constellation may include 2^{k} points selected from the set of points associated with the QPSK constellation, and the set of points may include a multiple of M QPSK symbols associated with the points for the QPSK constellation. In some aspects, the value for k may be selected such that M<k<2M. In some examples, a transmitting device or a receiving device may be configured to obtain the constellation from a table in accordance with the value for k and the value for M. Additionally, or alternatively, the transmitting device or the receiving device may be configured to obtain a linear code associated with the constellation, and the 2^{k} points may be selected using the linear code.

In some aspects, the linear code may be or may include a single parity code. For example, the symbols generated from a group of k bits may satisfy a parity check associated with the single parity code. In some aspects, the single parity code may be configured such that a phase transition between consecutive symbols of each set of M symbols are limited to π/2 radians or π/2 radians (e.g., 90 degrees or −90 degrees). Additionally, or alternatively, the modulation techniques may be configured such that a phase transition between bits of different sets of M symbols may be controlled. For example, a phase shift of π/4 radians may be applied between constellations for a last symbol of a first set of M symbols and for an initial symbol of a successive set of M symbols, such that a phase transition between the last symbol and the initial symbol may be limited to

$$\frac{π}{4} , \frac{3 π}{4} , - \frac{π}{4} , or - \frac{3 π}{4}$$

radians.

Particular aspects of the subject matter described in this disclosure can be implemented to realize one or more of the following potential advantages. In some examples, the modulation techniques described may be used to achieve a lower PAPR relative to QPSK modulation, which may improve connection stability when coverage is limited relative to using QPSK modulation. Additionally, the modulation techniques described may achieve a higher spectral efficiency relative to using π/2 BPSK modulation, which may improve transmission throughput relative to using π/2 BPSK modulation. In some aspects, while demodulation for the modulation techniques may be performed jointly for each set of M symbols, the demodulation is independent between different sets of M symbols. Consequently, the demodulation may be associated with reduced complexity and increased performance relative to using Trellis coding with QPSK modulation, as demodulation may be performed in parallel for different sets of M symbols. In some aspects, by applying a phase shift of π/4 radians to the last symbol of the first set of M symbols and an initial symbol of the successive set of M symbols, PAPR may be decreased relative to having non-controlled phase transitions between symbols of different sets of M symbols.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

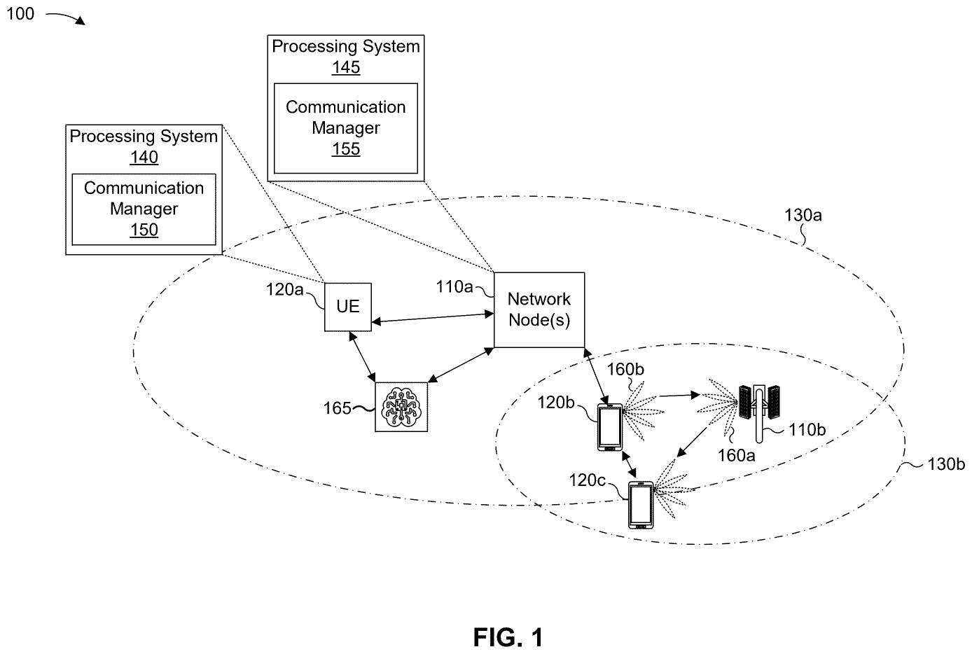

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHZ), FR2 (24.25 GHz through 52.6 GHz), FR3 (7.125 GHz through 24.25 GHZ), FR4a or FR4-1 (52.6 GHz through 71 GHz), FR4 (52.6 GHz through 114.25 GHZ), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder in accordance with one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift or transition, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified in accordance with measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some aspects, a transmitting device (e.g., a UE 120 or a network node 110) may include a communication manager (e.g., a communication manager 150, or a communication manager 155). As described in more detail elsewhere herein, the communication manager may obtain a constellation that comprises 2^{k} points selected from a set of points associated with M QPSK constellations, wherein k and M are positive integers; modulate one or more groups of k bits to one or more sets of M QPSK symbols based at least in part on the constellation, wherein each point of the 2^{k} points corresponds to a respective set of M QPSK symbols of the one or more sets of M QPSK symbols; and transmit a signal that includes the one or more sets of M QPSK symbols. Additionally, or alternatively, the communication manager may perform one or more other operations described herein.

In some aspects, the receiving device (e.g., a UE 120 or a network node 110) may include a communication manager (e.g., a communication manager 150, or a communication manager 155). As described in more detail elsewhere herein, the communication manager may receive a signal that includes one or more sets of M QPSK symbols; and demodulate the one or more sets of M QPSK symbols in accordance with a constellation to obtain one or more groups of k bits, wherein the constellation comprises 2^{k} points selected from a set of points associated with M QPSK constellations, wherein each point of the 2^{k} points corresponds to a respective set of M QPSK symbols of the one or more sets of M QPSK symbols, and wherein k and M are positive integers. Additionally, or alternatively, the communication manager may perform one or more other operations described herein.

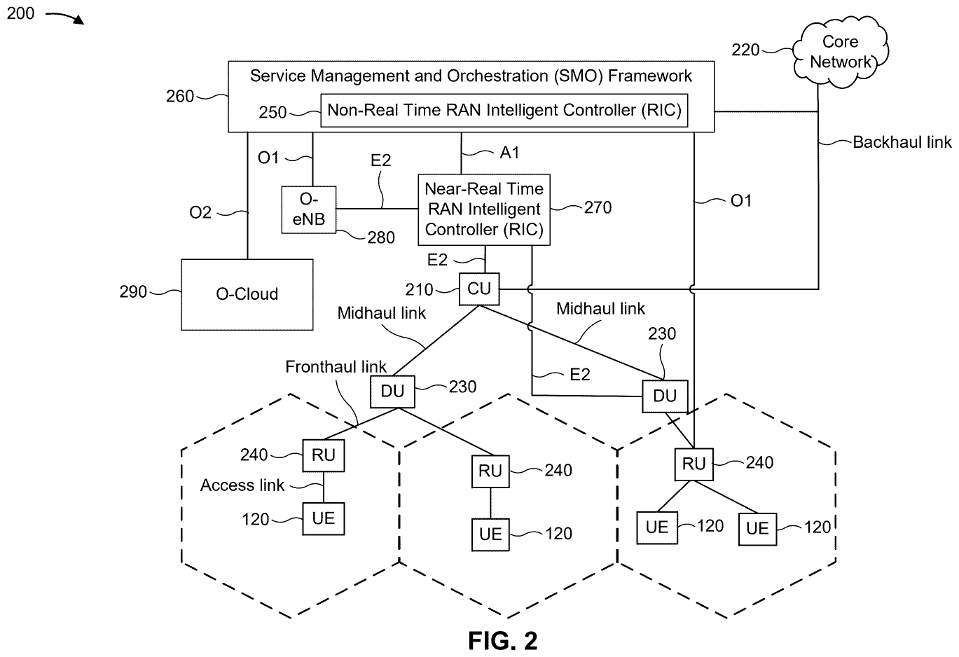

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

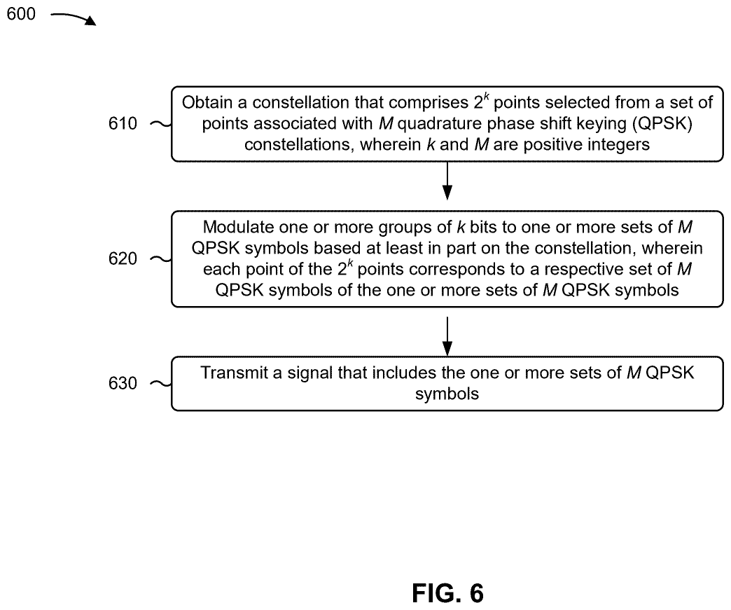

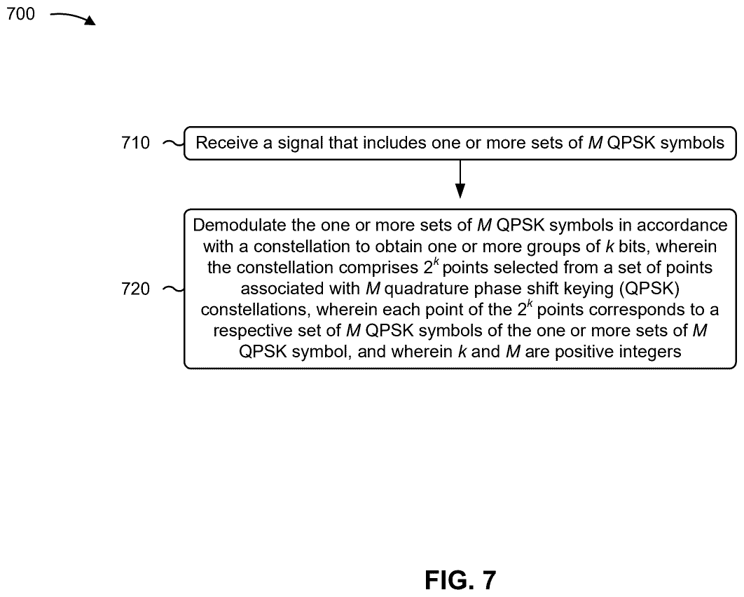

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with modulation techniques for low PAPR, as described in more detail elsewhere herein. For example, the processing system 145 of the network node 110, the processing system 140 of the UE 120, the CU 210, the DU 230, or the RU 240 may perform or direct operations of, for example, process 600 of FIG. 6, process 700 of FIG. 7, or other processes as described herein (alone or in conjunction with one or more other processors). In some aspects, the transmitting device or the receiving device described herein may be the network node 110, may be included in the network node 110, or may include one or more components of the network node 110 shown in FIG. 1. Additionally, or alternatively, the transmitting device or the receiving device described herein may be the UE 120, may be included in the UE 120, or may include one or more components of the UE 120 shown in FIG. 1. Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 600 of FIG. 6, process 700 of FIG. 7, or other processes as described herein. In some examples, executing instructions may include running the instructions, converting the instructions, compiling the instructions, or interpreting the instructions, among other examples.

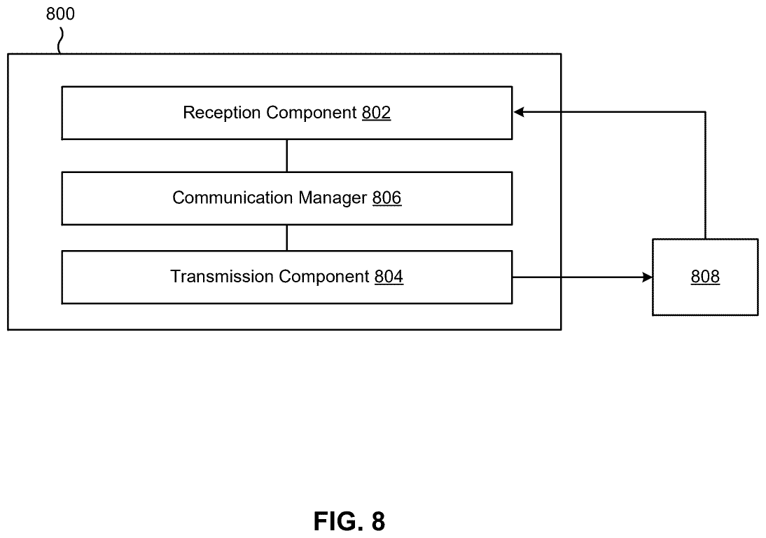

In some aspects, a transmitting device includes means for obtaining a constellation that comprises 2^{k} points selected from a set of points associated with M QPSK constellations, wherein k and M are positive integers; means for modulating one or more groups of k bits to one or more sets of M QPSK symbols based at least in part on the constellation, wherein each point of the 2^{k} points corresponds to a respective set of M QPSK symbols of the one or more sets of M QPSK symbols; or means for transmitting a signal that includes the one or more sets of M QPSK symbols. In some aspects, the transmitting device may be a network node 110, and the means for the transmitting device to perform operations described herein may include, for example, one or more of communication manager 155, processing system 145, a radio, one or more RF chains, one or more transceivers, one or more antennas, one or more modems, a reception component (for example, reception component 802 depicted and described in connection with FIG. 8), or a transmission component (for example, transmission component 804 depicted and described in connection with FIG. 8), among other examples. In some aspects, the transmitting device may be a UE 120, and the means for the transmitting device to perform operations described herein may include, for example, one or more of communication manager 150, processing system 140, a radio, one or more RF chains, one or more transceivers, one or more antennas, one or more modems, a reception component (for example, reception component 802 depicted and described in connection with FIG. 8), or a transmission component (for example, transmission component 804 depicted and described in connection with FIG. 8), among other examples.

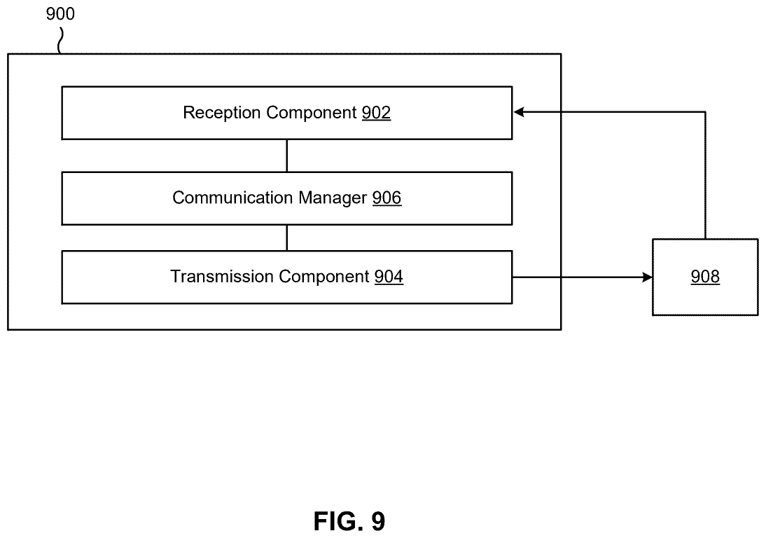

In some aspects, a receiving device includes means for receiving a signal that includes one or more sets of M QPSK symbols; or means for demodulating the one or more sets of M QPSK symbols in accordance with a constellation to obtain one or more groups of k bits, wherein the constellation comprises 2^{k} points selected from a set of points associated with M QPSK constellations, wherein each point of the 2^{k} points corresponds to a respective set of M QPSK symbols of the one or more sets of M QPSK symbols, and wherein k and M are positive integers. In some aspects, the receiving device may be a network node 110, and the means for the receiving device to perform operations described herein may include, for example, one or more of communication manager 155, processing system 145, a radio, one or more RF chains, one or more transceivers, one or more antennas, one or more modems, a reception component (for example, reception component 902 depicted and described in connection with FIG. 9), or a transmission component (for example, transmission component 904 depicted and described in connection with FIG. 9), among other examples. In some aspects, the receiving device may be a UE 120, and the means for the receiving device to perform operations described herein may include, for example, one or more of communication manager 150, processing system 140, a radio, one or more RF chains, one or more transceivers, one or more antennas, one or more modems, a reception component (for example, reception component 902 depicted and described in connection with FIG. 9), or a transmission component (for example, transmission component 904 depicted and described in connection with FIG. 9), among other examples.

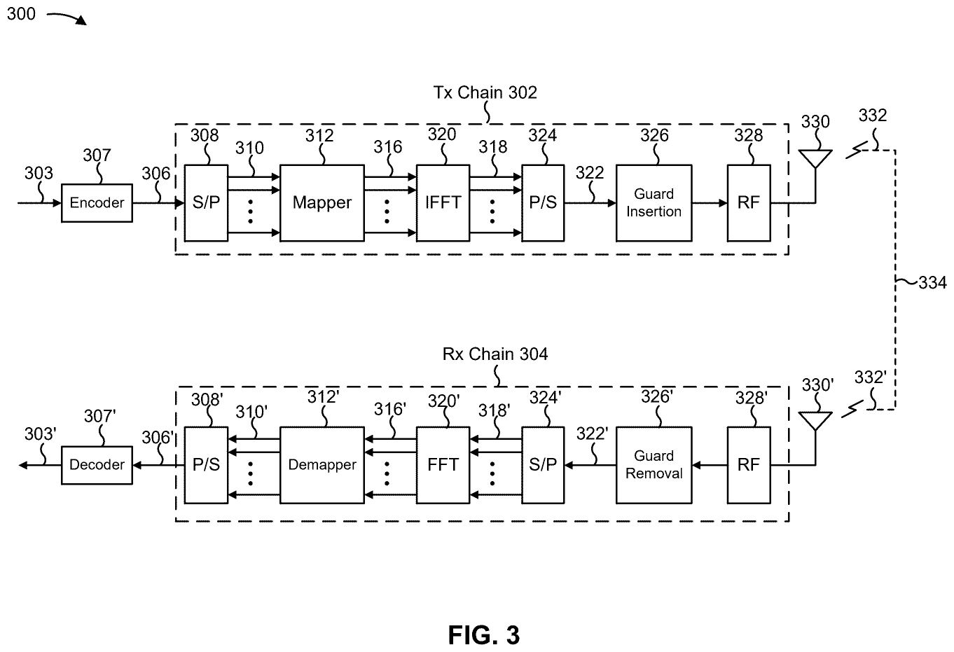

FIG. 3 is a diagram illustrating an example 300 of a transmit (Tx) chain 302 and a receive (Rx) chain 304. In some aspects, Tx chain 302 may be implemented in a transmitting device, such as a UE 120 for transmitting data 306 (for example, uplink data, an uplink reference signal, or uplink control information) to a network node 110 on an uplink channel or to another UE 120 on a sidelink channel. Additionally or alternatively, Tx chain 302 may be implemented in a network node 110 for transmitting data 306 (for example, downlink data, a downlink reference signal, or downlink control information) to a UE 120 on a downlink channel.

An encoder 307 may alter a signal (for example, a bitstream) 303 into data 306. Data 306 to be transmitted is provided from encoder 307 as input to a serial-to-parallel (S/P) converter 308. In some aspects, S/P converter 308 may split the transmission data into N parallel data streams 310.

The N parallel data streams 310 may then be provided as input to a mapper 312. Mapper 312 may map the N parallel data streams 310 onto N constellation points. The mapping may be done using a modulation constellation, as described herein, and the modulation constellation may include a BPSK, π/2 BPSK, QPSK, 8 phase-shift keying (8PSK), or a QAM, constellation, among other examples. Thus, the mapper 312 may output N parallel symbol streams 316, each symbol stream 316 corresponding to one of N orthogonal subcarriers of an IFFT component 320. The N parallel symbol streams 316 are represented in the frequency domain and may be converted into N parallel time domain sample streams 318 by IFFT component 320.

Additionally, or alternatively, the mapper 312 may use one or more modulation techniques as described herein. For example, the mapper 312 may be configured to implement modulation techniques using multi-dimensional constellations that may achieve decreased PAPR relative to QPSK modulation and increased spectral efficiency relative to π/2 BPSK modulation. In some aspects, the modulation techniques may use a constellation that includes a subset selected from points of a set of points associated with a QPSK constellation, and jointly modulating one or more groups of k bits of the sequence of bits to one or more sets of M symbols (e.g., QPSK symbols) using the subset of points. In some aspects, the constellation may be selected in accordance with the size of the groups of bits (e.g., k). For example, the constellation may include 2^{k} points selected from the set of points associated with the QPSK constellation. In some aspects, the value for k may be selected such that M<k<2M. In some examples, the mapper 312 may be configured to obtain the constellation from a table in accordance with the value for k and the value for M. Additionally, or alternatively, the mapper 312 may be configured to obtain a linear code associated with the constellation, and the 2^{k} points may be selected using the linear code. In some cases, the linear code may be or may include a single parity code, as described herein.

In some aspects, N parallel modulations in the frequency domain correspond to N modulation symbols in the frequency domain, which are equal to N mapping and N-point IFFT in the frequency domain, which are equal to one (useful) OFDM symbol in the time domain, which are equal to N samples in the time domain. One OFDM symbol in the time domain, Ns, is equal to Ncp (the number of guard samples per OFDM symbol)+N (the number of useful samples per OFDM symbol).

The N parallel time domain sample streams 318 may be converted into an OFDM/OFDMA symbol stream 322 by a parallel-to-serial (P/S) converter 324. A guard insertion component 326 may insert a guard interval between successive OFDM/OFDMA symbols in the OFDM/OFDMA symbol stream 322. The output of guard insertion component 326 may then be upconverted to a desired transmit frequency band by an RF front end 328. An antenna 330 may then transmit the resulting signal 332.

In some aspects, Rx chain 304 may utilize OFDM/OFDMA. In some aspects, Rx chain 304 may be implemented in a receiving device, such as a UE 120 for receiving data 306 (for example, downlink data, a downlink reference signal, or downlink control information) from a network node 110 on a downlink channel or from another UE 120 on a sidelink channel. Additionally or alternatively, Rx chain 304 may be implemented in network node 120 for receiving data 306 (for example, uplink data, an uplink reference signal, or uplink control information) from a UE 120 on an uplink channel.

A transmitted signal 332 is shown traveling over a wireless channel 334 from Tx chain 302 to Rx chain 304 (for example, from a UE 120 to a network node 110, from a network node 110 to a UE 120, or from a first UE 120 to a second UE 120, among other examples). When a signal 332′ is received by an antenna 330′, the received signal 332′ may be down-converted to a baseband signal by an RF front end 328′. A guard removal component 326′ may then remove the guard interval that was inserted between OFDM/OFDMA symbols by guard insertion component 326.

The output of guard removal component 326′ may be provided to an S/P converter 324′. The output may include an OFDM/OFDMA symbol stream 322′, and S/P converter 324′ may divide the OFDM/OFDMA symbol stream 322′ into N parallel time-domain symbol streams 318′, each of which corresponds to one of the N orthogonal subcarriers. An FFT component 320′ may convert the N parallel time-domain symbol streams 318′ into the frequency domain and output N parallel frequency-domain symbol streams 316′.

A demapper 312′ may perform the inverse of the symbol mapping operation that was performed by mapper 312, thereby outputting N parallel data streams 310′. A P/S converter 308′ may combine the N parallel data streams 310′ into a single data stream 306′. The data stream 306′ may correspond to data 306 that was provided as input to Tx chain 302. Data stream 306′ may be decoded into a decoded data stream 303′ by decoder 307′.

The number and arrangement of components shown in FIG. 3 are provided as an example. In practice, there may be additional components, fewer components, different components, or differently arranged components than those shown in FIG. 3. Furthermore, two or more components shown in FIG. 3 may be implemented within a single component, or a single component shown in FIG. 3 may be implemented as multiple, distributed components. Additionally or alternatively, a set of components (for example, one or more components) shown in FIG. 3 may perform one or more functions described as being performed by another set of components shown in FIG. 3.

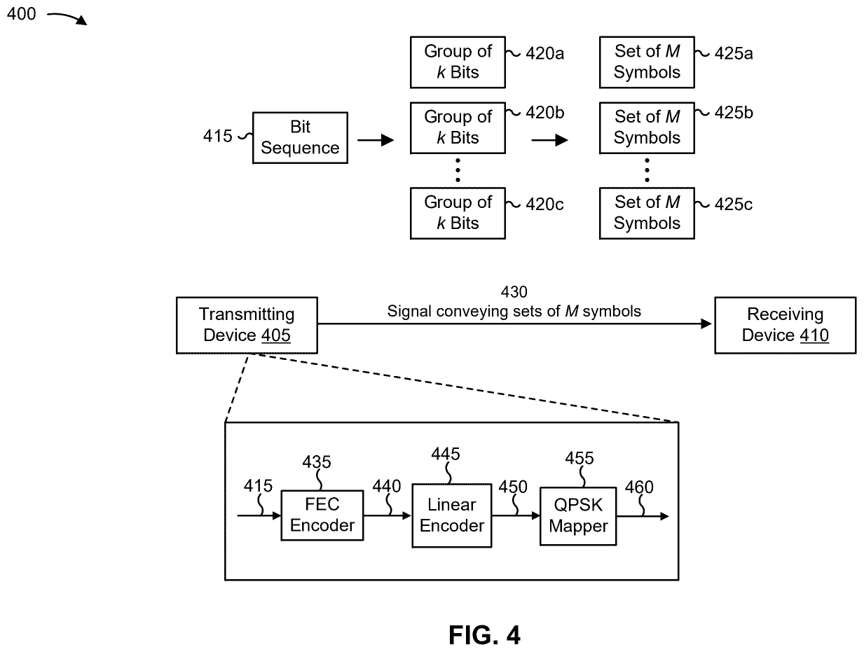

FIG. 4 is a diagram illustrating an example 400 of modulation techniques use multi-dimensional constellations to support low PAPR waveform. As shown in FIG. 4, a transmitting device 405 and a receiving device 410 may communicate with one another. In some examples, the transmitting device 405 may be a UE 120 or a network node 110 or may include components of a UE 120 or a network node 110, as described herein. Additionally, or alternatively, the receiving device 410 may be a UE 120 or a network node 110 or may include components of a UE 120 or a network node 110, as described herein.

In some aspects, the transmitting device 405 may implement modulation techniques that use multi-dimensional constellations with a low PAPR. For example, the transmitting device 405 may be configured to use modulation techniques that may achieve decreased PAPR relative to QPSK modulation but increased spectral efficiency relative to π/2 BPSK modulation. Additionally, or alternatively, the modulation techniques may be configured such that modulation is performed jointly across some bits, but across a relatively small quantity of bits relative to Trellis coding, thereby reducing modulation and demodulation complexity relative to Trellis coding.

The transmitting device 405 may modulate a bit sequence 415 including multiple bits to obtain one or more symbols for a waveform in accordance with a multi-dimensional constellation. In some cases, the waveform may be a DFT-s-OFDM waveform. In some aspects, the modulation may include jointly modulating groups of bits from multiple groups of bits of the bits sequence 415, which may allow for control of phase transitions between modulation symbols of the resulting waveform and a reduced PAPR associated with the waveform relative to QPSK modulation. In some examples, the groups of bits that are jointly modulated may have a fewer quantity of bits relative to bits encoded using Trellis coding, which may reduce modulation complexity for the transmitting device 405 and reduce demodulation complexity for the receiving device 410 relative to using Trellis coding.

For example, the transmitting device 405 may modulate one or more groups of k bits 420 (e.g., groups that each include k bits) of the bit sequence 415 to corresponding sets of M symbols 425. For instance, the bit sequence 415 may be divided into a first group of k bits 420a, a second group of k bits 420b, and a third group of k bits 420c. The transmitting device 405 may be configured to jointly modulate each bit of the first group of k bits 420a to obtain a first set of M symbols 425a. Similarly, the transmitting device 405 may be configured to modulate the second group of k bits 420b to a second set of M symbols 425b, and the third group of k bits 420c to a third set of M symbols 425c. The transmitting device 405 may then transmit a signal 430 that may convey each set of M symbols 425 to the receiving device 410, and the receiving device 410 may receive the signal 430 and demodulate the signal to obtain the bit sequence 415. Accordingly, the modulation techniques described herein may result in a spectral efficiency equivalent to k/M bits per complex dimension associated with a constellation for the modulation. While FIG. 4 illustrates an example where the bit sequence is divided into three groups of k bits 420, larger or smaller quantities of groups of k bits 420 and sets of M symbols can be used.

By jointly modulating a group of k bits 420 to a set of M symbols 425, the phase transition between modulation symbols of the set of M symbols 425 may be controlled, which may achieve a decreased PAPR relative to QPSK modulation. In some aspects, the receiving device 410 may perform demodulation jointly for the set of M symbols 425 to obtain the corresponding group of k bits 420. However, while demodulation may be performed jointly for the set of M symbols 425, the demodulation may be performed independently between different sets of M symbols 425, unlike Trellis coding. Consequently, the modulation techniques described herein may result in lower complexity demodulation and improved performance relative to using Trellis coding with QPSK modulation, as demodulation may be performed independently (e.g., in parallel) between different sets of M symbols 425.

In some aspects, to modulate each group of k bits 420 to a corresponding set of M symbols 425, the transmitting device may be configured to use a constellation A, which may be associated with a QPSK constellation (e.g., a four point constellation) including a set of points S_{QPSK}. In some aspects, the constellation A may be selected in accordance with the values for k and M. For example, the modulation techniques may include selecting a constellation A that includes a subset of points selected from a set of points

$${S}_{QPSK}^{M} ,$$

where

$${S}_{QPSK}^{M} = {S}_{QPSK} \times … \times {S}_{QPSK} ,$$

in accordance with the value for M (e.g., such that

$${S}_{Q P S K}^{M}$$

includes 4^{M} points). In some aspects, the subset of points of the constellation A may include 2^{k} points of the set of points

$${S}_{QPSK}^{M} .$$

In some examples, each point of the 2^{k} points may correspond to a vector (e.g., a sequence or group) of M QPSK symbols. For example, each QPSK symbol may be represented by a complex number, and each point of the 2^{k} points may be represented as a complex vector having a length M. Accordingly, each point of the 2^{k} points may correspond to a respective set of M QPSK symbols, which may be referred to as a multi-dimensional (e.g., M-complex dimensions) modulation symbol sequence.

In some aspects, a value for k and a value for M may be selected in accordance with a target PAPR or a target spectral efficiency. For example, when the value for k is equal to 2M, the constellation A includes all points in the set of points

$${S}_{QPSK}^{M} ( e . g . , A = {S}_{QPSK}^{M} , as {2}^{k} = {2}^{2 M} = {4}^{M} points )$$

and each group of k bits 420 is modulated to a set of k/2 symbols, which may be equivalent to QPSK modulation in terms of PAPR and spectral efficiency. Alternatively, when the value for k is equal to the value of M, each bit may be modulated to a corresponding symbol, where the optimal selection of constellation points (e.g., for reducing PAPR) may result in modulation equivalent to π/2 BPSK in terms of PAPR and spectral efficiency. Accordingly, in some aspects, the value for k and the value for M may be selected such that M<k<2M, which may result in a PAPR and a spectral efficiency between the PAPRs and spectral efficiencies for π/2 BPSK and for QPSK. In some aspects, the transmitting device 405 may select the values for k and M and may indicate the values to the receiving device 410. Additionally, or alternatively, the transmitting device 405 may be configured with values for k and M, or may receive an indication of the values from another device (e.g., a network node 110, or the receiving device 410).

In some examples, the values for k and M that satisfy M<k<2M may be selected in accordance with the target PAPR or the target spectral efficiency. For example, a selection where the value for k is closer to M than to 2M may result in a lower PAPR and a lower spectral efficiency relative to a selection where the value for k is closer to 2M than to M. In some examples, the values for k and M that satisfy M<k<2M may result in a spectral efficiency between one and two bits per complex dimension.

Additionally, or alternatively, the 2^{k} points for the constellation A may be selected to achieve the target PAPR (e.g., an optimal PAPR, or a lowest PAPR relative to other constellation points) or a target channel capacity (e.g., distance) for the modulation of the bit sequence 415. In some aspects, the transmitting device 405 may obtain the constellation A from a table in accordance with the value for k, the value for M, or a combination thereof. For example, the transmitting device 405 may be configured with one or more tables (e.g., look-up tables) that indicate points for the constellation A in accordance with the values for k and M, or the tables may be defined in a communication standard. For example, the one or more tables may be obtained using a search algorithm to determine the set of points for the constellation A in accordance with respective values for k or M to achieve a lowest PAPR (e.g., relative to other points for the constellation A). In some cases, the transmitting device 405 may receive the one or more tables from another device, such as a network node 110.

Additionally, or alternatively, the transmitting device 405 device may be configured to obtain a linear code associated with the constellation A. For example, the transmitting device 405 may be configured with one or more linear codes, and the set of points for the constellation A may be selected from the set of points

$${S}_{QPSK}^{M}$$

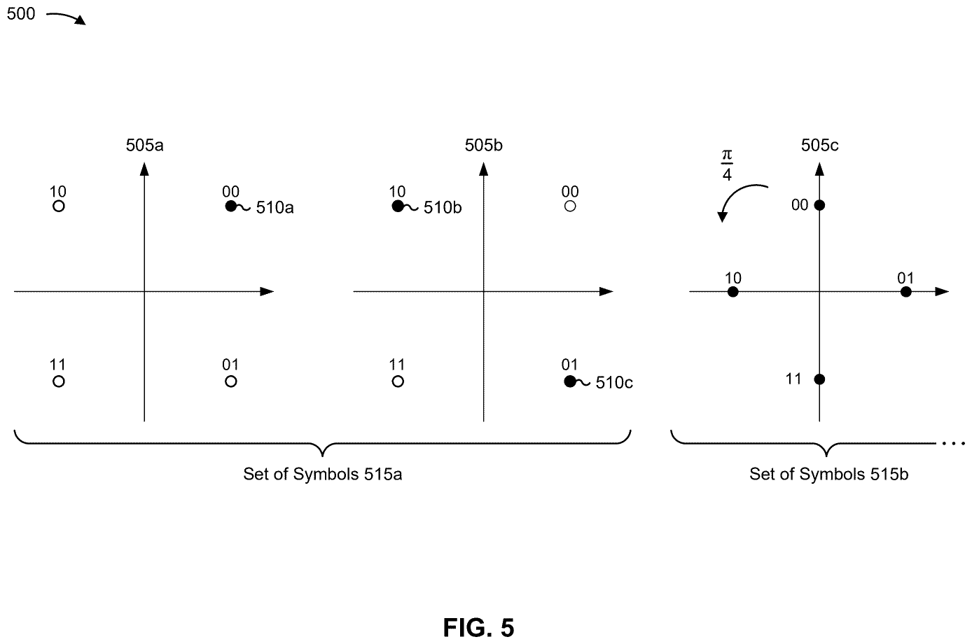

in accordance with at least one linear code of the one or more linear codes. In some cases, the at least one linear code may correspond to the selected values for k and M. In some aspects, the one or more linear codes may include one or more single parity codes, as described in further detail with reference to FIG. 5.

In some aspects, to perform the modulation of the bit sequence 415, the transmitting device 405 may apply the linear code to the bits of the bit sequence 415 to be modulated. In some examples, as shown in FIG. 4, the transmitting device 405 may first encode the bit sequence 415 using an FEC encoder 435 (e.g., an LDPC code or a polar code encoder), which may apply FEC to the bit sequence 415 (e.g., by performing one or more FEC operations). In some aspects, the FEC encoder 435 may output coded bits, which may include each bit for each of the groups of k bits 420. The transmitting device 405 may input the coded bits via a data stream 440 to a linear encoder 445, which may apply the linear code to the coded bits and may generate one or more parity bits in accordance with the at least one single parity codes. For example, for each group of k bits 420, the linear encoder 445 may generate a respective parity bit that satisfies a parity check associated with a single party code. In some examples, the data stream 440 may include multiple parallel data streams 440 that may correspond to the multiple groups of k bits 420. In some aspects, the linear encoder 445 may output extended coded bits (e.g., including the coded bits and the parity bits) and may input the extended coded bits, via a data stream 450, to a QPSK mapper 455. The QPSK mapper 455 may map the bits output by the linear encoder 445, which may include one or more parity bits, to one or more symbols (e.g., QPSK symbols, or modulation symbols). The QPSK mapper 455 may output the sets of M symbols 425 via a symbol stream 460. In some aspects, the symbol stream 460 may include multiple parallel symbol steams 460 corresponding to each set of M symbols 425. Accordingly, the transmitting device 405 may transmit the signal 430 that conveys each set of M symbols 425.

In some aspects, the receiving device 410 may include corresponding circuitry (not shown) for demodulating and decoding the signal 430. For example, the receiving device 410 may include a QPSK demapper that may be used to obtain one or more bits from each symbol conveyed by the signal 430. Additionally, or alternatively, the receiving device 410 may include a linear decoder that may check parity according to the one or more generated parity bits or may remove the one or more parity bits from the bits obtained using the QPSK demapper. In some aspects, the linear decoder may perform the decoding jointly for each group of bits obtained from a corresponding set of M symbols 425. Additionally, or alternatively, the receiving device 410 may include an FEC decoder, which may decode the bits obtained from the linear decoder in accordance with the one or more FEC operations. In some aspects, the transmitting device 405 or the receiving device 410 may include additional components not shown, such as the components described with reference to FIG. 3.

Accordingly, the transmitting device 405 and the receiving device 410 may communicate a bit sequence 415 in accordance with modulation techniques that may achieve reduced PAPR relative to QPSK modulation and improved spectral efficiency relative to π/2 BPSK modulation, while reducing modulation complexity relative to using Trellis coding.

As indicated above, FIG. 4 is provided as an example. Other examples may differ from what is described with respect to FIG. 4.

FIG. 5 is a diagram illustrating an example 500 of constellation diagrams that support low PAPR modulation. The example 500 includes a constellation diagram 505a, a constellation diagram 505b, and a constellation diagram 505b, which may illustrate modulation techniques for modulation one or more bits of a bit sequence into one or more symbols 510 (e.g., QPSK symbols). The modulation techniques may be implemented at a transmitting device (e.g., a transmitting device 405), a receiving device (e.g., a receiving device 410), a UE 120, a network node 110, or another device, as described herein.

In some aspects, the sequence of bits may be split into multiple groups of k bits, and each group of k bits may be modulated to a corresponding set of M symbols 515, as described herein. In some examples, to modulate a group of k bits, the transmitting device may apply a linear code to the group of k bits, which may be a single parity code. For example, the transmitting device may obtain (or be configured with) a (3,4) single parity code. In some examples, for an (x,y) single parity code, x may refer to the quantity of information bits, and y may refer to the total bits including the information bits and parity bits. In some cases, a “single parity” code may refer to that, for a given input, the single parity code may output a single parity bit (e.g., the single parity code may output the input and the single parity bit, such that y=x+1).

Accordingly, for the (3,4) single parity code, for every three information bits, a fourth parity bit is generated that satisfies a parity check associated with the (3, 4) single parity code. In some aspects, the (3,4) single parity code may be given by Equation 1 below:

$${a}_{1} + {a}_{2} + {a}_{3} + {a}_{4} = {a}_{1} - {a}_{3} + {a}_{2} - {a}_{4} = 1 \qquad ( 1 )$$

where a₁, a₂, and a₃ correspond to respective information bits of the set of k bits, and a₄ corresponds to the generated parity bit. In Equation 1, + corresponds to binary addition and − corresponds to binary subtraction, which may be equivalent. In some aspects, by using a single parity code where the parity check equation sums to a value of 1 (e.g., instead of a value of 0), the single parity code may enable for control of a phase transition between modulation symbols, thereby enabling a reduction of PAPR relative to QPSK modulation.

For example, by satisfying the parity check associated with the (3,4) single parity code, a phase transition between symbols may be limited to π/2 radians. The example 500 illustrates the case where k=3 and M=2, such that every group of 3 bits of the bit sequence are mapped to a set of 2 symbols. In cases where the first two bits of a first group of 3 bits are 00 (e.g., a₁=0 and a₂=0), the first symbol of a set of symbols 515a may be a symbol 510a, as shown in FIG. 5. When the third bit of the first group of 3 bits is 1 (e.g., a₃=1), then the parity bit is generated to have a value of 0 in accordance with the parity check associated with the (3,4) single parity code (e.g., a₄=0). Accordingly, the second symbol of the set of symbols 515a may be a symbol 510b. Alternatively, when the third bit of the first group of 3 bits is 0 (e.g., a₃=0), then the parity bit is generated to have a value of 1 in accordance with the parity check associated with the (3,4) single parity code (e.g., a₄=1), and the second symbol of the set of symbols 515a may be a symbol 510c.

Accordingly, a symbol successive to the symbol 510a within the set of symbols 515a may be limited to the symbol 510b or the symbol 510c. Therefore, a Hamming distance measured in accordance with a binary labeling between successive symbols of the set of symbols 515a is limited to 1. For example, if a first symbol has binary labeling 00, and a successive symbol has a binary labeling 01 or 10, the Hamming distance is always 1. Accordingly, the phase transition between the successive symbols may be limited to

$$\pm \frac{π}{2}$$

radians of the modulated waveform in accordance with the (3,4) single parity code. Additionally, the (3,4) single parity code may also limit the phase transition between successive symbols to

$$\pm \frac{π}{2}$$

radians when Gray mapping is used for modulation. For example, when using Gray mapping, for any two modulation points closest to each other in QPSK modulation, the binary labeling differs by only 1 bit, resulting in limiting the phase transition to

$$\pm \frac{π}{2}$$

radians. While FIG. 5 depicts an example where the initial two bits of the first group of 3 bits have a value of 00, the parity check associated with the (3,4) single parity code similarly limits the phase transition to

$$\pm \frac{π}{2}$$

radians for any value of bits of a group of k bits.

In some aspects, to support different values for k or for M, the transmitting device may be configured with multiple linear codes which may be associated with one or more parity codes. For example, to support the case where k=4 and M=3, the transmitting device may obtain or may be configured with a set of linear equations corresponding to a (4,6) linear code, as shown by Equations 2 and 3 below:

$${a}_{1} + {a}_{2} + {a}_{3} + {a}_{4} = 1 \qquad ( 2 )$$

$${a}_{3} + {a}_{4} + {a}_{5} + {a}_{6} = 1 \qquad ( 3 )$$

where a₁, a₂, a₃ and as correspond to respective information bits of a set of 4 bits, and a₄ and a₆ correspond to generated parity bits. The parity bits a₄ and a₆ may be generated to satisfy a parity check associated with the set of linear equations, in a similar manner as depicted with respect to the set of symbols 515a.

For example, following the example shown in FIG. 5, when the first three information bits of a group of 4 bits correspond to a₁=0, a₂=0, and a₃=1, the parity bit a₄ is generated to a value of 0 to satisfy the parity check. Therefore, the phase transition between a first symbol and a second symbol of a set of 3 symbols corresponding to the group of 4 bits is limited to

$$\pm \frac{π}{2}$$

radians. In the case where the fourth information bit a₅=1, the parity bit a₆ is generated to have a value of 0. Alternatively, in the case where the fourth information bit a₅=0, the parity bit a₆ is generated to have a value of 1. Accordingly, distance between the second symbol and the third symbol of the set of 3 symbols is also limited to 1, and the phase transition between each of the three symbols of the set of 3 symbols after modulation may be limited to

$$\pm \frac{π}{2}$$

radians.

Therefore, by applying one or more linear codes, a phase transition between symbols of a set of symbols 515 may be controlled, which may reduce a PAPR associated with a signal conveying the set of symbols 515 relative to QPSK modulation. However, while the phase transition between symbols of a set of symbols 515 may be limited to

$$\pm \frac{π}{2}$$

radians using the one or more linear codes, a phase transition between symbols of different sets of symbols 515 may still be uncontrolled (e.g., arbitrary).

Accordingly, in some aspects, a phase rotation may be applied between constellations corresponding to different sets of symbols 515. For example, between the constellation corresponding to the constellation diagram 505b and the constellation corresponding to the constellation diagram 505c, a phase rotation of π/4 radians may be applied. For example, the phase rotation of π/4 radians may be applied to all symbols of the set of symbols 515b, such that a phase transition between a last symbol of the set of symbols 515a and an initial symbol of the set of symbols 515b may be limited to

$$\pm \frac{π}{4} ,$$

or

$$\pm \frac{3 π}{4} radians .$$

Additionally, by applying the phase rotation of π/4 radians to all the symbols of the set of symbols 515b, the phase rotations between successive symbols of the group 515b may still be limited to

$$\pm \frac{π}{2}$$

radians, as described herein. Accordingly, the phase transition between last symbols of a set of symbols 515 and an initial symbol of a successive set of symbols 515 may be controlled, which may reduce PAPR for the signal conveying the sets of symbols 515 relative to using uncontrolled phase transitions between sets of symbols 515.

In some aspects, for modulation including more than two sets of symbols 515, the phase rotation of π/4 radians may be applied to every other set of symbols 515. For example, the phase rotation of π/4 radians may be applied to a second set of symbols 515, a fourth set of symbols 515, a sixth set of symbols 515, and so on, for each set of symbols in a modulation symbol group. Consequently, the phase transition between a last symbol of a first set of symbols 515 and an initial symbol the second set of symbols may be limited to ±π/4, or ±3π/4 radians, and similarly, the phase transition between a last symbol of the second set of symbols 515 and an initial symbol of a third set of symbols 515 may be limited to ±π/4, or ±3π/4 radians. Accordingly, the phase transition between successive symbols in different sets of symbols 515 may be limited to ±π/4, or ±3π/4 radians for successive symbols between all sets of symbols 515 of the modulation symbol group, while the phase transition between successive symbols within a same set of symbols 515 may be limited to ±π/2 radians.

As indicated above, FIG. 5 is provided as an example. Other examples may differ from what is described with respect to FIG. 5.

FIG. 6 is a diagram illustrating an example process 600 performed, for example, at a transmitting device or an apparatus of a transmitting device. Example process 600 is an example where the apparatus or the transmitting device (e.g., a transmitting device 405) performs operations associated with multi-dimensional constellations with low PAPR. In some aspects, the transmitting device may be an example of a UE 120 or a network node 110, as described herein.

As shown in FIG. 6, in some aspects, process 600 may include obtaining a constellation that comprises 2^{k} points selected from a set of points associated with M QPSK constellations, wherein k and M are positive integers (block 610). For example, the transmitting device (e.g., using reception component 802 or communication manager 806, depicted in FIG. 8) may obtain a constellation that comprises 2^{k} points selected from a set of points associated with M QPSK constellations, wherein k and M are positive integers, as described above.

As further shown in FIG. 6, in some aspects, process 600 may include modulating one or more groups of k bits to one or more sets of M QPSK symbols based at least in part on the constellation, wherein each point of the 2^{k} points corresponds to a respective set of M QPSK symbols of the one or more sets of M QPSK symbols (block 620). For example, the transmitting device (e.g., using communication manager 806, depicted in FIG. 8) may modulate one or more groups of k bits to one or more sets of M QPSK symbols based at least in part on the constellation, wherein each point of the 2^{k} points corresponds to a respective set of M QPSK symbols of the one or more sets of M QPSK symbols, as described above.

As further shown in FIG. 6, in some aspects, process 600 may include transmitting a signal that includes the one or more sets of M QPSK symbols (block 630). For example, the transmitting device (e.g., using transmission component 804 or communication manager 806) depicted in FIG. 8 may transmit a signal that includes the one or more sets of M QPSK symbols, as described above.

Process 600 may include additional aspects, such as any single aspect or any combination of aspects described below or in connection with one or more other processes described elsewhere herein.

In a first aspect, obtaining the constellation comprises obtaining the constellation from a table based at least in part on a first value for k and a second value for M.

In a second aspect, alone or in combination with the first aspect, obtaining the constellation comprises obtaining a linear code associated with the 2^{k} points selected from the set of points.

In a third aspect, alone or in combination with one or more of the first and second aspects, process 600 includes applying FEC to a set of information bits to obtain a set of coded bits, the set of coded bits comprising each bit of the one or more groups of k bits, and applying the linear code to the set of coded bits, wherein the one or more groups of k bits is based at least in part on applying the linear code.

In a fourth aspect, alone or in combination with one or more of the first through third aspects, process 600 includes generating, for each set of k bits of the one or more sets of k bits, a respective parity bit that satisfies a parity check associated with a single parity code. In some cases, for each set of k bits of the one or more sets of k bits, a sum of each bit of the set of k bits and the respective parity bit is equal to one. Additionally, or alternatively, for each set of M QPSK symbols of the one or more sets of M QPSK symbols, a phase transition between successive QPSK symbols of the set of M QPSK symbols is π/2 or −π/2 in accordance with the single parity code.

In a fifth aspect, alone or in combination with one or more of the first through fourth aspects, process 600 includes applying an additional phase transition between a last QPSK symbol and an initial QPSK symbol of successive sets of M QPSK symbols of the one or more sets of M QPSK symbols.

In a sixth aspect, alone or in combination with one or more of the first through fifth aspects, the additional phase transition is π/4.

In a seventh aspect, alone or in combination with one or more of the first through sixth aspects, a first value for k is greater than a second value for M, and the first value is less than twice the second value.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at a receiving device or an apparatus of a receiving device. Example process 700 is an example where the apparatus or the receiving device (e.g., receiving device 410) performs operations associated with multi-dimensional constellations with low PAPR. In some aspects, the receiving device may be an example of a UE 120 or a network node 110, as described herein.

As shown in FIG. 7, in some aspects, process 700 may include receiving a signal that includes one or more sets of M QPSK symbols (block 710). For example, the receiving device (e.g., using reception component 902 or communication manager 906, depicted in FIG. 9) may receive a signal that includes one or more sets of M QPSK symbols, as described above.

As further shown in FIG. 7, in some aspects, process 700 may include demodulating the one or more sets of M QPSK symbols in accordance with a constellation to obtain one or more groups of k bits, wherein the constellation comprises 2^{k} points selected from a set of points associated with M QPSK constellations, wherein each point of the 2^{k} points corresponds to a respective set of M QPSK symbols of the one or more sets of M QPSK symbols, and wherein k and M are positive integers (block 720). For example, the receiving device (e.g., using communication manager 906, depicted in FIG. 9) may demodulate the one or more sets of M QPSK symbols in accordance with a constellation to obtain one or more groups of k bits, wherein the constellation comprises 2^{k} points selected from a set of points associated with M QPSK constellations, wherein each point of the 2^{k} points corresponds to a respective set of M QPSK symbols of the one or more sets of M QPSK symbols, and wherein k and M are positive integers, as described above.

Process 700 may include additional aspects, such as any single aspect or any combination of aspects described below or in connection with one or more other processes described elsewhere herein.

In a first aspect, process 700 includes obtaining the constellation from a lookup table based at least in part on a first value for k and a second value for M.

In a second aspect, alone or in combination with the first aspect, process 700 includes obtaining a linear code associated with the 2^{k} points selected from the set of points.

In a third aspect, alone or in combination with one or more of the first and second aspects, process 700 includes decoding the one or more sets of M QPSK symbols using the linear code, wherein demodulating the one or more sets of M QPSK symbols is based at least in part on decoding the one or more sets of M QPSK symbols.

In a fourth aspect, alone or in combination with one or more of the first through third aspects, each set of M QPSK symbols of the one or more sets of M QPSK symbols includes a respective parity bit that satisfies a parity check associated with a single parity code. In some cases, for each set of M QPSK symbols of the one or more sets of M QPSK symbols, a sum of each QPSK symbol of the set of M QPSK symbols and the respective parity bit is equal to one. Additionally, or alternatively, for each set of M QPSK symbols of the one or more sets of M QPSK symbols, a phase transition between successive QPSK symbols of the set of M QPSK symbols is π/2 or −π/2 in accordance with the single parity code.

In a fifth aspect, alone or in combination with one or more of the first through fourth aspects, an additional phase transition is applied between a last QPSK symbol and an initial QPSK symbol of successive sets of M QPSK symbols of the one or more sets of M QPSK symbols.

In a sixth aspect, alone or in combination with one or more of the first through fifth aspects, the additional phase transition is π/4.

In a seventh aspect, alone or in combination with one or more of the first through sixth aspects, a first value for k is greater than a second value for M, and the first value is less than twice the second value.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication. The apparatus 800 may be a transmitting device (e.g., a transmitting device 405), or a transmitting device may include the apparatus 800. In some examples, the transmitting device may be a UE 120 or a network node 110, as described herein. In some aspects, the apparatus 800 includes a reception component 802, a transmission component 804, or a communication manager 806, which may be in communication with one another (for example, via one or more buses or one or more other components). In some aspects, the communication manager 806 is the communication manager 150 or the communication manager 155 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 140 or the processing system 145 described in connection with FIG. 1) of the transmitting device.

In some aspects, the apparatus 800 may be configured to perform one or more operations described herein in connection with FIGS. 3-5X. Additionally, or alternatively, the apparatus 800 may be configured to perform one or more processes described herein, such as process 600 of FIG. 6, process 700 of FIG. 7, or a combination thereof. In some aspects, the apparatus 800 or one or more components shown in FIG. 8 may include one or more components of the transmitting device described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the transmitting device described above in connection with FIG. 1, such as a radio, one or more RF chains, one or more transceivers, or one or more modems, each of which may in turn be coupled with one or more antennas of the transmitting device.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the transmitting device described above in connection with FIG. 1, such as a radio, one or more RF chains, one or more transceivers, or one or more modems, each of which may in turn be coupled with one or more antennas of the transmitting device described in connection with FIG. 1. In some aspects, the transmission component 804 may be co-located with the reception component 802.

The communication manager 806 may support operations of the reception component 802 or the transmission component 804. For example, the communication manager 806 may receive information associated with configuring reception of communications by the reception component 802 or transmission of communications by the transmission component 804. Additionally, or alternatively, the communication manager 806 may generate or provide control information to the reception component 802 or the transmission component 804 to control reception or transmission of communications.

The reception component 802 may obtain a constellation that comprises 2^{k} points selected from a set of points associated with M QPSK constellations, wherein k and M are positive integers. The communication manager 806 may modulate one or more groups of k bits to one or more sets of M QPSK symbols based at least in part on the constellation, wherein each point of the 2^{k} points corresponds to a respective set of M QPSK symbols of the one or more sets of M QPSK symbols. The transmission component 804 may transmit a signal that includes the one or more sets of M QPSK symbols.

The communication manager 806 may apply forward error correction to a set of information bits to obtain a set of coded bits, the set of information bits comprising each bit of the one or more groups of k bits.

The communication manager 806 may apply the linear code to the set of coded bits, wherein the one or more groups of k bits is based at least in part on applying the linear code.

The communication manager 806 may generate, for each set of M QPSK symbols of the one or more sets of M QPSK symbols, a respective parity bit that satisfies a parity check associated with a single parity code.

The communication manager 806 may apply an additional phase transition between a last QPSK symbol and an initial QPSK symbol of successive sets of M QPSK symbols of the one or more sets of M QPSK symbols.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication. The apparatus 900 may be a receiving device, or a receiving device may include the apparatus 900. In some aspects, the apparatus 900 includes a reception component 902, a transmission component 904, or a communication manager 906, which may be in communication with one another (for example, via one or more buses or one or more other components). In some examples, the transmitting device may be a UE 120 or a network node 110, as described herein. In some aspects, the communication manager 906 is the communication manager 150 or the communication manager 155 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 140 or the processing system 145 described in connection with FIG. 1) of the receiving device.

In some aspects, the apparatus 900 may be configured to perform one or more operations described herein in connection with FIGS. 3-5. Additionally, or alternatively, the apparatus 900 may be configured to perform one or more processes described herein, such as process 600 of FIG. 6, process 700 of FIG. 7, or a combination thereof. In some aspects, the apparatus 900 or one or more components shown in FIG. 9 may include one or more components of the receiving device described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the receiving device described above in connection with FIG. 1, such as a radio, one or more RF chains, one or more transceivers, or one or more modems, each of which may in turn be coupled with one or more antennas of the receiving device.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the receiving device described above in connection with FIG. 1, such as a radio, one or more RF chains, one or more transceivers, or one or more modems, each of which may in turn be coupled with one or more antennas of the receiving device described in connection with FIG. 1. In some aspects, the transmission component 904 may be co-located with the reception component 902.

The communication manager 906 may support operations of the reception component 902 or the transmission component 904. For example, the communication manager 906 may receive information associated with configuring reception of communications by the reception component 902 or transmission of communications by the transmission component 904. Additionally, or alternatively, the communication manager 906 may generate or provide control information to the reception component 902 or the transmission component 904 to control reception or transmission of communications.

The reception component 902 may receive a signal that includes one or more sets of M QPSK symbols. The communication manager 906 may demodulate the one or more sets of M QPSK symbols in accordance with a constellation to obtain one or more groups of k bits, wherein the constellation comprises 2^{k} points selected from a set of points associated with M QPSK constellations, wherein each point of the 2^{k} points corresponds to a respective set of M QPSK symbols of the one or more sets of M QPSK symbols, and wherein k and M are positive integers.

The reception component 902 may obtain the constellation from a lookup table based at least in part on a first value for k and a second value for M.

The reception component 902 may obtain a linear code associated with the 2^{k} points selected from the set of points.

The communication manager 906 may decode the one or more sets of M QPSK symbols using the linear code, wherein demodulating the one or more sets of M QPSK symbols is based at least in part on decoding the one or more sets of M QPSK symbols.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a transmitting device, comprising: obtaining a constellation that comprises 2^{k} points selected from a set of points associated with M QPSK constellations, wherein k and M are positive integers; modulating one or more groups of k bits to one or more sets of M QPSK symbols based at least in part on the constellation, wherein each point of the 2^{k} points corresponds to a respective set of M QPSK symbols of the one or more sets of M QPSK symbols; and transmitting a signal that includes the one or more sets of M QPSK symbols.

Aspect 2: The method of Aspect 1, wherein obtaining the constellation comprises: obtaining the constellation from a table based at least in part on a first value for k and a second value for M.

Aspect 3: The method of any of Aspects 1-2, wherein obtaining the constellation comprises: obtaining a linear code associated with the 2^{k} points selected from the set of points.

Aspect 4: The method of Aspect 3, further comprising: applying FEC to a set of information bits to obtain a set of coded bits, the set of coded bits comprising each bit of the one or more groups of k bits; and applying the linear code to the set of coded bits, wherein the one or more groups of k bits is based at least in part on applying the linear code.

Aspect 5: The method of any of Aspects 1-4, further comprising: generating, for each group of k bits of the one or more groups of k bits, a respective parity bit that satisfies a parity check associated with a single parity code.

Aspect 6: The method of Aspect 5, wherein, for each group of k bits of the one or more groups of k bits, a sum of each bit of the group of k bits and the respective parity bit is equal to one.

Aspect 7: The method of any of Aspects 5-6, wherein, for each set of M QPSK symbols of the one or more sets of M QPSK symbols, a phase transition between successive QPSK symbols of the set of M QPSK symbols is π/2 or −π/2 in accordance with the single parity code.

Aspect 8: The method of Aspect 7, further comprising: applying an additional phase transition between a last QPSK symbol and an initial QPSK symbol of successive sets of M QPSK symbols of the one or more sets of M QPSK symbols.

Aspect 9: The method of Aspect 8, wherein the additional phase transition is π/4.

Aspect 10: The method of any of Aspects 1-9, wherein a first value for k is greater than a second value for M, and the first value is less than twice the second value.

Aspect 11: A method of wireless communication performed by receiving device, comprising: receiving a signal that includes one or more sets of M QPSK symbols; and demodulating the one or more sets of M QPSK symbols in accordance with a constellation to obtain one or more groups of k bits, wherein the constellation comprises 2^{k} points selected from a set of points associated with M QPSK constellations, wherein each point of the 2^{k} points corresponds to a respective set of M QPSK symbols of the one or more sets of M QPSK symbols, and wherein k and M are positive integers.

Aspect 12: The method of Aspect 11, further comprising: obtaining the constellation from a lookup table based at least in part on a first value for k and a second value for M.

Aspect 13: The method of any of Aspects 11-12, further comprising: obtaining a linear code associated with the 2^{k} points selected from the set of points.

Aspect 14: The method of Aspect 13, further comprising: decoding the one or more sets of M QPSK symbols using the linear code, wherein demodulating the one or more sets of M QPSK symbols is based at least in part on decoding the one or more sets of M QPSK symbols.

Aspect 15: The method of any of Aspects 11-14, wherein each set of M QPSK symbols of the one or more sets of M QPSK symbols includes a respective parity bit that satisfies a parity check associated with a single parity code.

Aspect 16: The method of Aspect 15, wherein, for each set of M QPSK symbols of the one or more sets of M QPSK symbols, a sum of each QPSK symbol of the set of M QPSK symbols and the respective parity bit is equal to one.

Aspect 17: The method of any of Aspects 15-16 wherein, for each set of M QPSK symbols of the one or more sets of M QPSK symbols, a phase transition between successive QPSK symbols of the set of M QPSK symbols is π/2 or −π/2 in accordance with the single parity code.

Aspect 18: The method of Aspect 17, wherein an additional phase transition is applied between a last QPSK symbol and an initial QPSK symbol of successive sets of M QPSK symbols of the one or more sets of M QPSK symbols.

Aspect 19: The method of Aspect 18, wherein the additional phase transition is π/4.

Aspect 20: The method of any of Aspects 11-19, wherein a first value for k is greater than a second value for M, and the first value is less than twice the second value.

Aspect 21: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-20.

Aspect 22: An apparatus for wireless communication at a device, the apparatus comprising one or more memories and one or more processors coupled to the one or more memories, the one or more processors configured to cause the device to perform the method of one or more of Aspects 1-20.

Aspect 23: An apparatus for wireless communication, the apparatus comprising at least one means for performing the method of one or more of Aspects 1-20.

Aspect 24: A non-transitory computer-readable medium storing code for wireless communication, the code comprising instructions executable by one or more processors to perform the method of one or more of Aspects 1-20.

Aspect 25: A non-transitory computer-readable medium storing a set of instructions for wireless communication, the set of instructions comprising one or more instructions that, when executed by one or more processors of a device, cause the device to perform the method of one or more of Aspects 1-20.

Aspect 26: A device for wireless communication, the device comprising a processing system that includes one or more processors and one or more memories coupled with the one or more processors, the processing system configured to cause the device to perform the method of one or more of Aspects 1-20.

Aspect 27: An apparatus for wireless communication at a device, the apparatus comprising one or more memories and one or more processors coupled to the one or more memories, the one or more processors individually or collectively configured to cause the device to perform the method of one or more of Aspects 1-20.

Aspect 28: A device comprising a processing system that includes one or more processors and one or more code-storing memories coupled with the one or more processors, the processing system configured to cause the device to perform the method of one or more of Aspects 1-20.

Aspect 29: A device comprising a processing system that includes processor circuitry and code-storing memory circuitry, the processing system configured to cause the device to perform the method of one or more of Aspects 1-20.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A transmitting device, comprising:
a processing system that includes one or more processors and one or more code-storing memories coupled with the one or more processors, the processing system configured to cause the transmitting device to:
obtain a constellation that comprises 2^{k} points selected from a set of points associated with M quadrature phase shift keying (QPSK) constellations, wherein k and M are positive integers;
modulate one or more groups of k bits to one or more sets of M QPSK symbols based at least in part on the constellation, wherein each point of the 2^{k} points corresponds to a respective set of M QPSK symbols of the one or more sets of M QPSK symbols; and
transmit a signal that includes the one or more sets of M QPSK symbols.

2. The transmitting device of claim 1, wherein the processing system, to cause the transmitting device to obtain the constellation, is configured to cause the transmitting device to:
obtain the constellation from a table based at least in part on a first value for k and a second value for M.

3. The transmitting device of claim 1, wherein the processing system, to cause the transmitting device to obtain the constellation, is configured to cause the transmitting device to:
obtain a linear code associated with the 2^{k} points selected from the set of points.

4. The transmitting device of claim 3, wherein the processing system is configured to cause the transmitting device to:
apply forward error correction to a set of information bits to obtain a set of coded bits, the set of coded bits comprising each bit of the one or more groups of k bits; and
apply the linear code to the set of coded bits, wherein the one or more groups of k bits are based at least in part on applying the linear code.

5. The transmitting device of claim 1, wherein the processing system is configured to cause the transmitting device to:
generate, for each group of k bits of the one or more groups of k bits, a respective parity bit that satisfies a parity check associated with a single parity code.

6. The transmitting device of claim 5, wherein, for each group of k bits of the one or more groups of k bits, a sum of each bit of the set of k bits and the respective parity bit is equal to one.

7. The transmitting device of claim 5, wherein, for each set of M QPSK symbols of the one or more sets of M QPSK symbols, a phase transition between successive QPSK symbols of the set of M QPSK symbols is π/2 or −π/2 in accordance with the single parity code.

8. The transmitting device of claim 7, wherein the processing system is configured to cause the transmitting device to:
apply an additional phase transition between a last QPSK symbol and an initial QPSK symbol of successive sets of M QPSK symbols of the one or more sets of M QPSK symbols.

9. The transmitting device of claim 8, wherein the additional phase transition is π/4.

10. The transmitting device of claim 1, wherein a first value for k is greater than a second value for M, and the first value is less than twice the second value.

11. A receiving device, comprising:
a processing system that includes one or more processors and one or more code-storing memories coupled with the one or more processors, the processing system configured to cause the receiving device to:
receive a signal that includes one or more sets of M quadrature phase shift keying (QPSK) symbols; and
demodulate the one or more sets of M QPSK symbols in accordance with a constellation to obtain one or more groups of k bits, wherein the constellation comprises 2^{k} points selected from a set of points associated with M QPSK constellations, wherein each point of the 2^{k} points corresponds to a respective set of M QPSK symbols of the one or more sets of M QPSK symbols, and wherein k and M are positive integers.

12. The receiving device of claim 11, wherein the processing system is configured to cause the receiving device to:
obtain the constellation from a lookup table based at least in part on a first value for k and a second value for M.

13. The receiving device of claim 11, wherein the processing system is configured to cause the receiving device to:
obtain a linear code associated with the 2^{k} points selected from the set of points.

14. The receiving device of claim 13, wherein the processing system is configured to cause the receiving device to:
decode the one or more sets of M QPSK symbols using the linear code, wherein demodulating the one or more sets of M QPSK symbols is based at least in part on decoding the one or more sets of M QPSK symbols.

15. The receiving device of claim 11, wherein each set of M QPSK symbols of the one or more sets of M QPSK symbols includes a respective parity bit that satisfies a parity check associated with a single parity code.

16. The receiving device of claim 15, wherein, for each set of M QPSK symbols of the one or more sets of M QPSK symbols, a sum of each QPSK symbol of the set of M QPSK symbols and the respective parity bit is equal to one.

17. The receiving device of claim 15, wherein, for each set of M QPSK symbols of the one or more sets of M QPSK symbols, a phase transition between successive QPSK symbols of the set of M QPSK symbols is π/2 or −π/2 in accordance with the single parity code.

18. The receiving device of claim 17, wherein an additional phase transition is applied between a last QPSK symbol and an initial QPSK symbol of successive sets of M QPSK symbols of the one or more sets of M QPSK symbols.

19. The receiving device of claim 18, wherein the additional phase transition is π/4.

20. The receiving device of claim 11, wherein a first value for k is greater than a second value for M, and the first value is less than twice the second value.

21. A method of wireless communication performed by a transmitting device, comprising:
obtaining a constellation that comprises 2^{k} points selected from a set of points associated with M quadrature phase shift keying (QPSK) constellations, wherein k and M are positive integers;
modulating one or more groups of k bits to one or more sets of M QPSK symbols based at least in part on the constellation, wherein each point of the 2^{k} points corresponds to a respective set of M QPSK symbols of the one or more sets of M QPSK symbols; and
transmitting a signal that includes the one or more sets of M QPSK symbols.

22. The method of claim 21, wherein obtaining the constellation comprises:
obtaining the constellation from a table based at least in part on a first value for k and a second value for M.

23. The method of claim 21, wherein obtaining the constellation comprises:
obtaining a linear code associated with the 2^{k} points selected from the set of points.

24. The method of claim 23, further comprising:
applying forward error correction to a set of information bits to obtain a set of coded bits, the set of coded bits comprising each bit of the one or more groups of k bits; and
applying the linear code to the set of coded bits, wherein the one or more groups of k bits are based at least in part on applying the linear code.

25. The method of claim 21, further comprising:
generating, for each group of k bits of the one or more groups of k bits, a respective parity bit that satisfies a parity check associated with a single parity code.

26. The method of claim 25, wherein, for each group of k bits of the one or more groups of k bits, a sum of each bit of the set of k bits and the respective parity bit is equal to one.

27. The method of claim 25, wherein, for each set of M QPSK symbols of the one or more sets of M QPSK symbols, a phase transition between successive QPSK symbols of the set of M QPSK symbols is π/2 or −π/2 in accordance with the single parity code.

28. The method of claim 27, further comprising:
applying an additional phase transition between a last QPSK symbol and an initial QPSK symbol of successive sets of M QPSK symbols of the one or more sets of M QPSK symbols.

29. The method of claim 28, wherein the additional phase transition is π/4.

30. A method of wireless communication performed by receiving device, comprising:
receiving a signal that includes one or more sets of M quadrature phase shift keying (QPSK) symbols; and
demodulating the one or more sets of M QPSK symbols in accordance with a constellation to obtain one or more groups of k bits, wherein the constellation comprises 2^{k} points selected from a set of points associated with M QPSK constellations, wherein each point of the 2^{k} points corresponds to a respective set of M QPSK symbols of the one or more sets of M QPSK symbols, and wherein k and M are positive integers.
